(19) United States
(12) Patent Application Publication
(10) Pub. No.: US 2020/0131354 A1
(43) Pub. Date: Apr. 30, 2020

(54) MOLDING COMPOSITIONS

(71) Applicants: Owen Maher, Farmington Hills, MI (US); Matthew Delaney, Canton, MI (US)

(72) Inventors: Owen Maher, Farmington Hills, MI (US); Matthew Delaney, Canton, MI (US)

(21) Appl. No.: 16/670,048

(22) Filed: Oct. 31, 2019

Related U.S. Application Data
(60) Provisional application No. 62/753,201, filed on Oct. 31, 2018.

(51) Int. Cl. C08L 23/12; C08L 1/02

(52) U.S. Cl. CPC C08L 23/12; C08L 2205/16; C08L 1/02

(57) ABSTRACT

A molding composition includes, by weight, 40% to 80% of polypropylene, up to 50% of glass fibers, up to 40% of cellulose fibers, up to 50% of basalt fibers, and 4% to 12% of additives.

### BACKGROUND

Injection molded components typically include a base thermoplastic polymer, such as polypropylene, polyamide, or others. These polymers often contain fillers that serve to enhance specific properties. For instance, glass fibers may be used to increase strength, and talc may be used to increase stiffness. In many end-use applications, such as in vehicles, there is also a desire to reduce weight. Despite that desire, it is difficult to reduce weight without sacrificing mechanical properties.

### SUMMARY

A molding composition according to an example of the present disclosure includes, by weight, 40% to 80% of polypropylene, 5% to 50% of glass fibers, 5% to 40% of cellulose fibers, and 4% to 12% of additives.

A molding composition according to an example of the present disclosure includes, by weight, 40% to 80% of polypropylene, 5% to 50% of basalt fibers, 5% to 40% of cellulose fibers, and 4% to 12% of additives.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a composition in the form of pellets.

### DETAILED DESCRIPTION

There is the challenge of reducing weight of a thermoplastic component, while maintaining acceptable mechanical properties. For example, glass fibers and/or talc are used as a filler to enhance mechanical properties. Glass fibers and talc, however, have a relatively high density. As a result, the increase in properties also increases weight. For example, mold in color thermoplastic olefins (TPO) are used for vehicles which require good dimensional stability, scratch resistance, surface aesthetics, and color retention/UV performance Example compositions used for these products include talc, which has a density on average of 2.75 g/cc and represents 20% of the product by weight. The use of cellulose fibers can reinforce plastic similar to talc but at a reduced density of 1.6 g/cc, offering a 40% reduction in fillers weight. Similarly, basalt fibers can provide reinforcement similar to glass fibers, but with a reduction in density. The amount of talc and/or glass fibers can thus be reduced and offset with cellulose fibers and/or basalt fibers to help achieve a lower weight while still achieving part performance and material properties required.

Cellulose and/or basalt fibers can be added prior to a molding process by blending a cellulose-filled or basalt-filled thermoplastic with a glass fiber product and neat thermoplastic (no fillers). However, blending at the point of molding requires blending equipment and maintaining the blend ratio in order to obtain consistent material performance and composition. If the blend is not correct, the material performance will vary versus the specified, desired composition.

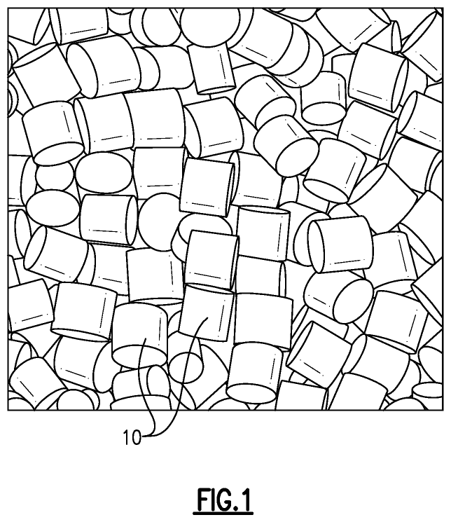

The disclosed example compositions are provided as a pre-manufactured molding composition. Accordingly, the composition can then be used at the point of molding to mold an end-use component, without the need to blend various products together at the point of molding. For instance, as shown in FIG. 1, the composition can be provided in the form of pellets 10 that are manufactured in a compounding process. The pellets contain the final, desired composition and are used directly in an injection molding process to form end-use components.

Example compositions generally include a thermoplastic, such as polypropylene, polyamide, or polybutylene terephthalate, cellulose and/or basalt fibers, and one or more additives. The additives include, but are not limited to, one or more of anti-oxidants, heat stabilizers, coupling agents, and colorants. Most typically, the compositions will include each of anti-oxidants, heat stabilizers, coupling agents, and colorants. The additives are not particularly limited and may include, but are not limited to, phenolic antioxidants, hindered amines, organic and/or inorganic pigments, dyes, stearates, and anhydrides.

In examples, the amount of cellulose fibers by weight in the composition is not more than 50%. For instance, the amount is 20% to 40%, 5% to 20%, or 10% to 30%. In examples, the amount of basalt fibers by weight in the composition is not more than 50%. For instance, the amount is 5% to 20%, 25% to 50%, or 15% to 30%. In further examples with basalt fibers, the composition additionally includes carbon fibers to facilitate increasing mechanical performance for structural applications. For instance, the composition includes ______% to ______% carbon fibers. In further example compositions that include glass fibers, the amount of glass fibers by weight in the composition is not more than 50%. For instance, the amount is 20% to 50%, 55 to 20%, 20% to 40%, or 25% to 50%. It is to be understood that each composition herein assumes 100% total and that all percentages herein are by weight. The following compositions demonstrate additional examples according to the present disclosure.

Composition 1

| | |
|---|---|
| Polypropylene: Copolymer or Homopolymer | 40% to 80% |
| Glass Fiber | 5% to 50% |
| Cellulose Fiber | 5% to 40% |
| Coupling Agent | 2% to 6% |
| Anti-Oxidant | 0.5% to 1.5% |
| Heat Stabilizer | 0.5% to 1.5% |
| Black Colorant | 1% to 3% |

Composition 2

| | |
|---|---|
| Polypropylene, polyamide, | 40% to 80% |
| or polybutylene terephthalate: | |
| Basalt fiber | 5% to 50% |
| Coupling Agent | 2% to 6% |
| Anti-Oxidant | 0.5% to 1.5% |
| Heat Stabilizer | 0.5% to 1.5% |
| Black Colorant | 1% to 3% |

Composition 3

| | |
|---|---|
| Polypropylene: Copolymer or Homopolymer | 40% to 80% |
| Basalt Fiber | 5% to 50% |
| Cellulose Fiber | 5% to 40% |
| Coupling Agent | 2% to 6% |
| Anti-Oxidant | 0.5% to 1.5% |
| Heat Stabilizer | 0.5% to 1.5% |
| Black Colorant | 1% to 3% |

Although a combination of features is shown in the illustrated examples, not all of them need to be combined to realize the benefits of various embodiments of this disclosure. In other words, a system designed according to an embodiment of this disclosure will not necessarily include all of the features shown in any one of the FIGURES or all of the portions schematically shown in the FIGURES. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A molding composition comprising, by weight, 40% to 80% of polypropylene, 5% to 50% of glass fibers, 5% to 40% of cellulose fibers, and 4% to 12% of additives.

2. The molding composition as recited in claim 1, wherein, by weight, the amount of glass fibers is greater than the amount of cellulose fibers.

3. The molding composition as recited in claim 2, wherein the glass fibers are 20% to 50%.

4. The molding composition as recited in claim 1, wherein the glass fibers are 5% to 20%.

5. The molding composition as recited in claim 1, wherein the glass fibers are 20% to 40%.

6. The molding composition as recited in claim 1, wherein the glass fibers are 35% to 50%.

7. The molding composition as recited in claim 1, wherein the cellulose fibers are 20% to 40%.

8. The molding composition as recited in claim 1, wherein the cellulose fibers are 5% to 20%.

9. The molding composition as recited in claim 1, wherein the cellulose fibers are 10% to 30%.

10. The molding composition as recited in claim 1, wherein the molding composition is in the form of pellets.

11. A molding composition comprising, by weight, 40% to 80% of a thermoplastic selected from polypropylene, polyamide, and polybutylene terephthalate, 5% to 50% of basalt fibers, and 4% to 12% of additives.

12. The molding composition as recited in claim 12, wherein the basalt fibers are 5% to 20%.

13. The molding composition as recited in claim 12, wherein the basalt fibers are 25% to 50%.

14. The molding composition as recited in claim 12, wherein the basalt fibers are 15% to 30%.

15. A molding composition comprising, by weight, 40% to 80% of polypropylene, 5% to 50% of basalt fibers, 5% to 40% of cellulose fibers, and 4% to 12% of additives.

16. The molding composition as recited in claim 15, wherein, by weight, the amount of the basalt fibers is greater than the amount of the cellulose fibers.

17. The molding composition as recited in claim 15, wherein the basalt fibers are 20% to 50%

18. The molding composition as recited in claim 15, wherein the basalt fibers are 15% to 30%.

19. The molding composition as recited in claim 15, wherein the cellulose fibers are 5% to 20%.

20. The molding composition as recited in claim 15, wherein the cellulose fibers are 10% to 30%.
